(19) United States
(12) Patent Application Publication
(10) Pub. No.: US 2026/0169683 A1
(43) Pub. Date: Jun. 18, 2026

(54) CONTROL APPARATUS AND METHOD OF OPERATING CONTROL APPARATUS

(71) Applicant: TOYOTA JIDOSHA KABUSHIKI KAISHA, Toyota-shi (JP)

(72) Inventors: Naoki UENOYAMA, Kasugai-shi (JP); Takeshi FUJIKI, Fukuoka-shi (JP); Chikage KUBO, Chofu-shi (JP)

(73) Assignee: TOYOTA JIDOSHA KABUSHIKI KAISHA, Toyota-shi (JP)

(21) Appl. No.: 19/415,632

(22) Filed: Dec. 10, 2025

(30) Foreign Application Priority Data
Dec. 12, 2024 (JP) 2024-217760

(51) Int. Cl. G06F 3/16; B60K 35/10; G10L 15/22

(52) U.S. Cl. CPC G06F 3/167; B60K 35/10; G10L 15/22; B60K 2360/148; G10L 2015/223

(57) ABSTRACT

A control apparatus includes an input interface configured to accept an instruction from a user's speech, a display configured to display information to the user, and a controller configured to, upon receiving a predetermined instruction to transition to a second operation mode that accepts an instruction from the user's speech while in a first operation mode that stops accepting an instruction from the user's speech, cause the display to display first information that prompts the user to speak and second information other than the first information in different manners from each other.

### CROSS-REFERENCE TO RELATED APPLICATION

This application claims priority to Japanese Patent Application No. 2024-217760, filed on Dec. 12, 2024, the entire contents of which are incorporated herein by reference.

### TECHNICAL FIELD

The present disclosure relates to a control apparatus and a method of operating the control apparatus.

### BACKGROUND

In-vehicle apparatuses provided with agent functions that recognize requests included in the speech of occupants of vehicles and provide responses or services to the requests are known. For example, Patent Literature (PTL) 1 discloses an in-vehicle apparatus that identifies an instruction including a so-called wake-up word to activate an agent function.

### CITATION LIST

### Patent Literature

PTL 1: WO 2022/254669 A1

### SUMMARY

There is room for improvement in user convenience in control apparatuses for vehicles that provide services in response to speech.

Hereinafter, a control apparatus and the like that can improve user convenience will be disclosed.

A control apparatus according to the present disclosure includes:
an input interface configured to accept an instruction from a user's speech;
a display configured to display information to the user; and
a controller configured to, upon receiving a predetermined instruction to transition to a second operation mode that accepts an instruction from the user's speech while in a first operation mode that stops accepting an instruction from the user's speech, cause the display to display first information that prompts the user to speak and second information other than the first information in different manners from each other.

Another aspect of the present disclosure is a method of operating a control apparatus including an input interface configured to accept an instruction from a user's speech and a display configured to display information to the user, the method including, upon receiving a predetermined instruction to transition to a second operation mode that accepts an instruction from the user's speech while in a first operation mode that stops accepting an instruction from the user's speech, causing the display to display first information that prompts the user to speak and second information other than the first information in different manners from each other.

According to the control apparatus and the like in the present disclosure, it is possible to improve user convenience.

### BRIEF DESCRIPTION OF THE DRAWINGS

In the accompanying drawings:

FIG. 1 is a diagram illustrating an example configuration of an information provision system;

FIG. 2 is a diagram illustrating an example configuration of a control apparatus;

FIG. 3 is a flowchart illustrating an example operation procedure of the control apparatus;

FIG. 4A is an example of display of information in the control apparatus;

FIG. 4B is an example of display of information in the control apparatus;

FIG. 5A is an example of display of information in the control apparatus; and

FIG. 5B is an example of display of information in the control apparatus.

### DETAILED DESCRIPTION

An embodiment will be described below with reference to the drawings.

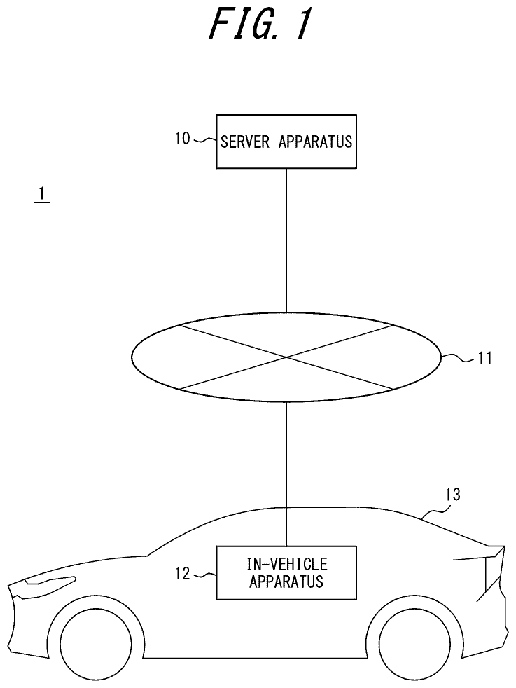

FIG. 1 is a diagram illustrating an example configuration of a vehicle control system according to the embodiment. A vehicle control system 1 includes at least one server apparatus 10, and at least one in-vehicle apparatus 12 mounted in at least one vehicle 13, which are communicably connected to each other via a network 11. The server apparatus 10 is, for example, one or more server computers that belong to a cloud computing system or another computing system and that function as a server that implements various functions. The vehicle 13 is a passenger car, commercial vehicle, or the like, and is an internal combustion engine vehicle, Hybrid Electric Vehicle (HEV), Plug-in Hybrid Electric Vehicle (PHEV), or the like. The in-vehicle apparatus 12 has a computer with communication and information processing functions, and provides various information and controls operations of the vehicle 13 according to operations by a user of the vehicle 13. The user may be a driver or passenger of the vehicle 13. The network 11 may include, for example, a mobile communication network, the Internet, an ad hoc network, a local area network (LAN), a metropolitan area network (MAN), other networks, or any combination thereof.

The in-vehicle apparatus 12, as a “control apparatus” in the present embodiment, accepts instructions from speech input or operations by the user of the vehicle 13, and provides various information to the user through voice output or image display and controls equipment such as audio, air conditioning, windows, sunroof, or seats of the vehicle 13, while communicating with the server apparatus 10 as appropriate, thereby providing convenience to the user. Upon receiving a predetermined instruction (hereinafter referred to as a transition instruction) to transition to a second operation mode (hereinafter referred to as a speech response mode) that accepts instructions from the user's speech while in a first operation mode (hereinafter referred to as a standby mode) that stops accepting instructions from the user's speech, the in-vehicle apparatus 12 displays first information (hereinafter referred to as speech response information) that prompts the user to speak and second information (hereinafter referred to as operation response information) other than the speech response information in different manners from each other. Here, the transition instruction is a predetermined operation by the user, such as speaking a specific wake-up word or operating a physical switch or the like. The switch is provided, for example, on the steering wheel, dashboard, or the like, and receives an operation such as pressing or pushing. The standby mode is an operation mode that accepts instructions from the user through operations on a touch panel, physical switches, or the like, in addition to the transition instruction, and provides information and control according to the instructions. Upon receiving the transition instruction in the standby mode, the in-vehicle apparatus 12 displays the operation response information in a manner different from the speech response information, such as displaying the operation response information in a color or brightness that is less visible than the speech response information or hiding the operation response information, and transitions to the speech response mode. This makes it easier for the user to grasp that the user should speak according to the speech response mode, thus avoiding unnecessary confusion for the user. In the speech response mode, the in-vehicle apparatus 12 accepts instructions from the user's speech, in addition to instructions from the user's operations, and provides information and control according to the instructions. Therefore, according to the present embodiment, user convenience can be improved.

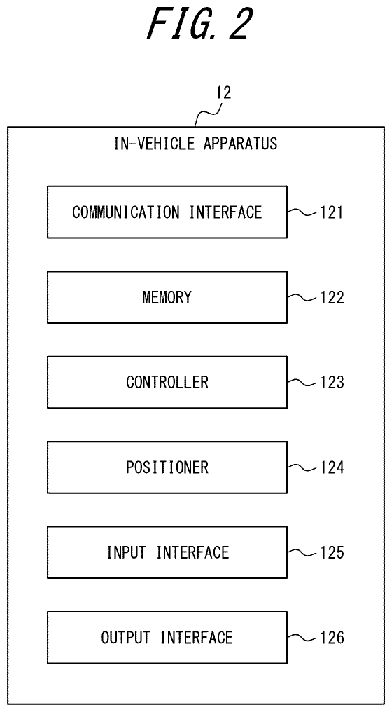

FIG. 2 illustrates an example configuration of the in-vehicle apparatus 12. The in-vehicle apparatus 12 includes a communication interface 121, a memory 122, a controller 123, a positioner 124, an input interface 125, and an output interface 126. These components may be configured as a single control apparatus, as two or more control apparatuses, or with another apparatus such as a control apparatus and a communication device. The control apparatus includes, for example, an electronic control unit (ECU) or the like. The communication device includes, for example, a data communication module (DCM) or the like. The components are communicably connected to each other or to equipment in the vehicle 13, through an in-vehicle network compliant with a standard such as a controller area network (CAN). The in-vehicle apparatus 12 may be configured to include, as a component, an information processing apparatus such as a smartphone or tablet terminal.

The communication interface 121 has a module compliant with a mobile communication standard such as Long Term Evolution (LTE), 4th Generation (4G) standard, or 5th Generation (5G) standard, a module compliant with in-vehicle LAN such as CAN, or the like. The in-vehicle apparatus 12 performs, via the communication interface 121, information communication with other apparatuses via the network 11 connected through a nearby router apparatus or a mobile communication base station, or information communication with each component of the vehicle 13 via the in-vehicle LAN.

The memory 122 includes one or more semiconductor memories, one or more magnetic memories, one or more optical memories, or a combination of at least two of these types. The semiconductor memories are, for example, random access memory (RAM) or read only memory (ROM). The RAM is, for example, static RAM (SRAM) or dynamic RAM (DRAM). The ROM is, for example, electrically erasable programmable ROM (EEPROM). The memory 122 functions as, for example, a main memory, an auxiliary memory, or a cache memory. The memory 122 stores information to be used for operations of the controller 123 and information obtained by operations of the controller 123.

The controller 123 includes one or more processors, one or more dedicated circuits, or a combination thereof. The processors are general purpose processors, such as central processing units (CPUs), or dedicated processors, such as graphics processing units (GPUs), specialized for particular processing. The dedicated circuits are, for example, field-programmable gate arrays (FPGAs), application specific integrated circuits (ASICs), or the like. The controller 123 executes information processing related to operations of the in-vehicle apparatus 12 while controlling components of the in-vehicle apparatus 12.

The functions of the controller 123 are realized by execution of a control/processing program by a processor included in the controller 123. The control/processing program is a program for causing a computer to execute processing of steps included in the operations of the controller 123, thereby enabling the computer to realize the functions corresponding to the processing of the steps. That is, the control/processing program is a program for causing a computer to function as the controller 123. Some or all of the functions of the controller 123 may be realized by a dedicated circuit included in the controller 123.

The positioner 124 includes one or more global navigation satellite system (GNSS) receivers. The GNSS includes, for example, global positioning system (GPS), quasi-zenith satellite system (QZSS), BeiDou, global navigation satellite system (GLONASS), and/or Galileo. The positioner 124 transmits a positioning result to the controller 123, and the controller 123 calculates positional information on the in-vehicle apparatus 12.

The input interface 125 includes one or more interfaces for input. The interfaces for input include, for example, a microphone that accepts voice input from a user's speech, physical keys, capacitive keys, a pointing device, a touch screen integrally provided with a display, and the like. Additionally, the interfaces for input include interfaces with various input devices arranged in the vehicle. The various input devices include a camera that captures images inside the vehicle and a physical switch for a transition instruction. The switch for a transition instruction is arranged on the console panel, steering wheel, or the like. The input interface 125 accepts operations for inputting various information, including a user's voice, and transmits the input information to the controller 123 or transmits the captured images to the controller 123.

The output interface 126 includes one or more interfaces for output. The interfaces for output may include, for example, a speaker and a display. The display of the output interface 126 corresponds to a ‘display’ of the present embodiment. The display is, for example, a liquid crystal display (LCD) or an organic electro-luminescence (EL) display, and is installed in a location that is easily visible to a user in the driver's seat or passenger seat, such as the dashboard, or in any location easily visible to a user in the back seat. Additionally, the interfaces for output include interfaces for transmitting control signals to various equipment such as the air conditioning, windows, sunroof, and seats of the vehicle 13. The output interface 126 outputs information obtained from operations of the controller 123 in the form of audio, or displays the information in the form of images.

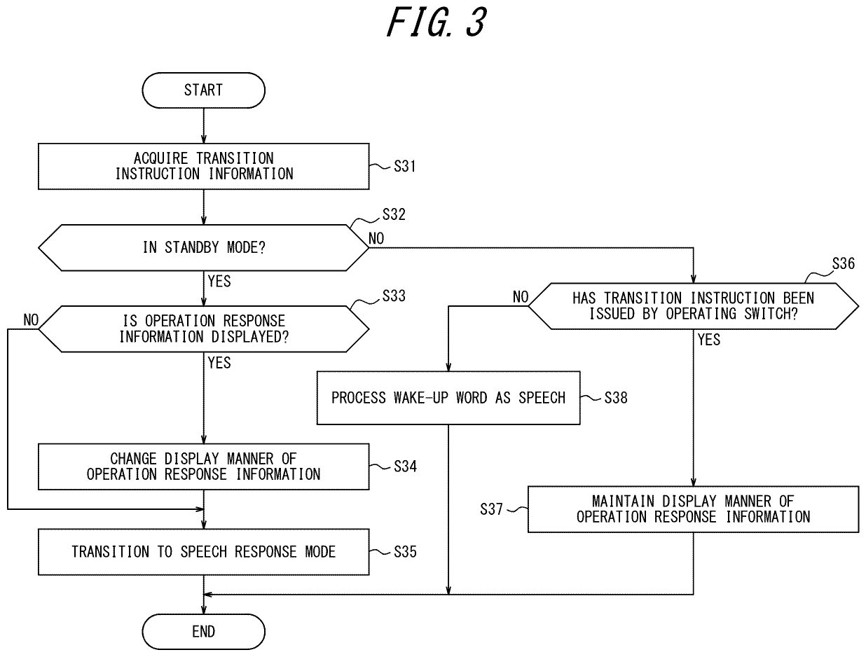

FIG. 3 is a flowchart illustrating an operation procedure of the in-vehicle apparatus 12. Each step in FIG. 3 is a step of information processing executed by the controller 123 of the in-vehicle apparatus 12.

The procedure in FIG. 3 is executed when the controller 123 has received a transition instruction. The transition instruction is issued by a user speaking a pre-set phrase, e.g., a wake-up word such as ‘Start dialogue mode’ or ‘Hey, XX’ (where XX is the manufacturer name of the vehicle 13 or the system name). Alternatively, the transition instruction is issued by the user's operation of a switch for a transition instruction. When the input interface 125 transmits data on voice of the wake-up word from the microphone to the controller 123, the controller 123 acquires a transition instruction by detecting the wake-up word from the voice through voice recognition processing. When the input interface 125 accepts input from the user's operation of the switch for a transition instruction and transmits the accepted information to the controller 123, the controller 123 acquires the transition instruction by receiving the information from the input interface 125. Upon acquiring the transition instruction, the controller 123 stores transition instruction information corresponding to the transition instruction in the memory 122, and starts the procedure in FIG. 3.

In S31, the controller 123 acquires the transition instruction information. The transition instruction information includes information to determine whether the transition instruction has been issued with the wake-up word or by operating the switch for the transition instruction. The controller 123 reads and acquires the transition instruction information stored in the memory 122.

In S32, the controller 123 determines whether the controller 123 is currently in a standby mode. The controller 123 determines whether the controller 123 is in a standby mode, with reference to information indicating an operation mode stored in the memory 122. When the controller 123 is in the standby mode (Yes in step S32), the controller 123 proceeds to step S33. When the controller 123 is not in the standby mode, that is, in a speech response mode (No in step S32), the controller 123 proceeds to step S36.

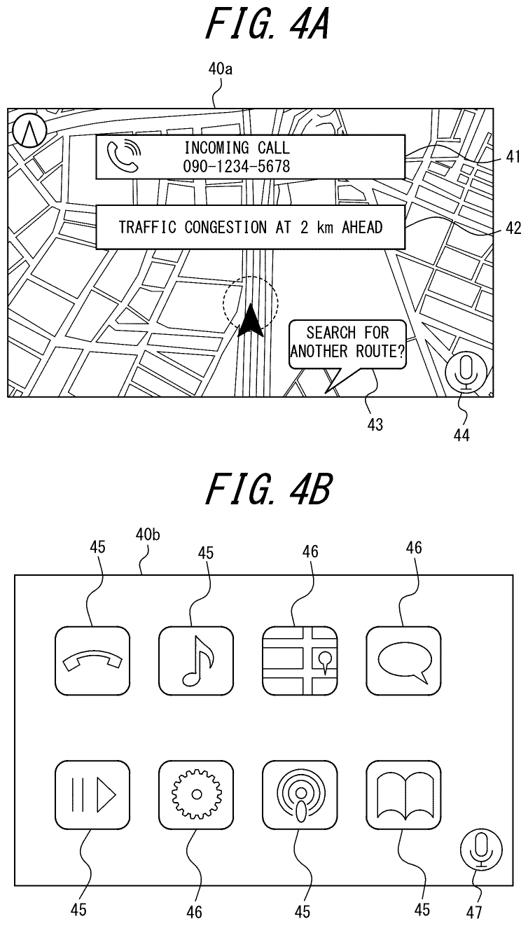

In S33, the controller 123 determines the presence or absence of display of operation response information. The controller 123 determines whether operation response information is displayed on a display of the output interface 126. The controller 123 causes the display to display information corresponding to the user's operations on a touch panel integrated with the display or various physical switches. The display of the output interface 126 displays, for example, a screen 40a as illustrated in FIG. 4A, or a screen 40b as illustrated in FIG. 4B.

The screen 40a in FIG. 4A includes a map for providing navigation. The screen 40a includes notifications 41 and 42 corresponding to the operation response information and objects 43 and 44 corresponding to speech response information, which are overlaid on the map. The notifications 41 and 42 are notifications corresponding to various events occurring during navigation, and prompt the user to perform a tap operation or the like to start operations related to each notification. For example, the notification 41 is a banner notifying an incoming call in the communication interface 121. When the user taps on the notification 41, the controller 123 starts a hands-free call. The notification 42 is a push notification displayed by the controller 123 in response to the communication interface 121 receiving information indicating the occurrence of traffic congestion via vehicle-to-vehicle communication or road traffic information distribution. When the user taps on the notification 42, the controller 123 further displays details of the traffic information. The object 43 is a pop-up notification object that allows the controller 123 to suggest an alternate route to the user, in response to the notification 42 of the traffic information, and is an object prompting the user for an instruction via speech. The object 44 is an icon object that prompts the user for an instruction via speech, by indicating that it is possible to accept the user's speech.

The screen 40b in FIG. 4B is a menu screen for providing various services including multimedia to the user. The screen 40b includes objects 46 corresponding to the operation response information, and objects 45 and 47 corresponding to speech response information. The objects 46 are objects that prompt the user to perform a tap operation to start an interface screen for a map, messages, function settings, or the like. The objects 45 are objects that prompt an instruction from the user's speech to start a phone function or various audio applications. The object 47 is an object that prompts an instruction from the user's speech by indicating that the user's speech is acceptable.

Returning to FIG. 3, when the operation response information is displayed in step S33 (Yes in step S33), the controller 123 proceeds to step S34. When the operation response information is not displayed (No in step S33), the controller 123 bypasses step S34 and proceeds to step S35.

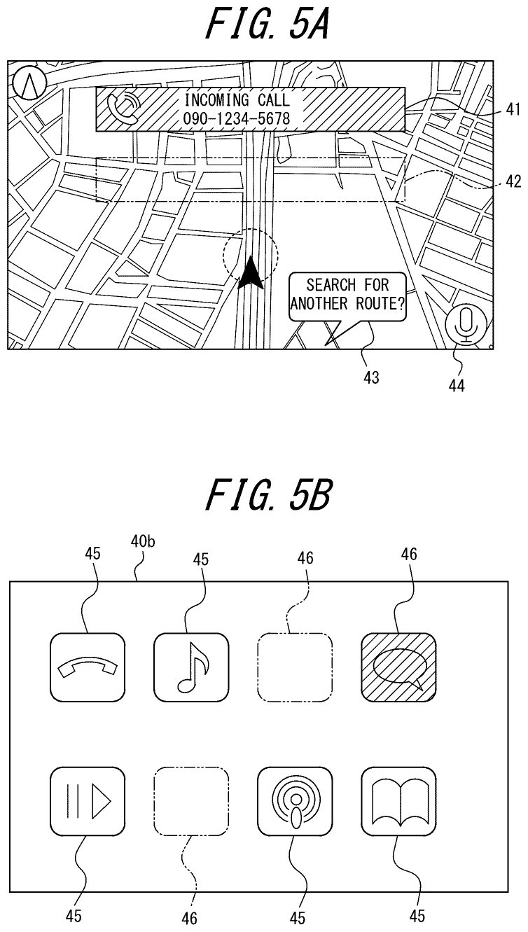

In S34, the controller 123 changes the display manner of the operation response information. The controller 123 changes the display manner of the operation response information, which is displayed on the display of the output interface 126, to a different display manner from that of the speech response information. For example, the controller 123 may display the operation response information in a color or brightness that is less visible than the speech response information, or hide the operation response information. FIGS. 5A and 5B illustrate examples of changes in the display manner of the operation response information.

FIG. 5A illustrates an example of changes in the display manner of the notifications 41 and 42 corresponding to the operation response information, on the screen 40a illustrated in FIG. 4A. For example, on the display of the output interface 126, the controller 123 displays the notification 41 in a manner with reduced visibility, such as masking or lowering brightness, or hides the notification 42, thereby displaying the notifications 41 and 42 in different display manners from the objects 43 and 44 corresponding to the speech response information. The controller 123 may display, for example, the object 44 corresponding to the speech response information in a more conspicuous display manner by increasing brightness or the like, while reducing the visibility of the notifications 41 and 42 corresponding to the operation response information. Alternatively, the controller 123 may introduce a new object corresponding to the speech response information.

FIG. 5B illustrates an example of changes in the display manner of the objects 46 corresponding to the operation response information, on the screen 40b illustrated in FIG. 4B. For example, on the display of the output interface 126, the controller 123 displays the objects 46 in a manner with reduced visibility, such as masking or lowering brightness, or hides the objects 46, thereby displaying the objects 46 in different display manners from the objects 45 and 47 corresponding to the speech response information. The controller 123 may display, for example, the object 47 corresponding to the speech response information in a more conspicuous display manner by increasing brightness or the like, while reducing the visibility of the objects 46 corresponding to the operation response information. Alternatively, the controller 123 may introduce a new object corresponding to the speech response information.

FIGS. 5A and 5B illustrate examples in which part of the operation response information is hidden and the visibility of the other of the operation response information is reduced, but all of the operation response information may be hidden or have its visibility reduced.

Returning to FIG. 3, in step S35, the controller 123 transitions to a speech response mode. In the speech response mode, the controller 123 converts voice acquired by the input interface 125 into text through voice recognition processing, analyzes the syntax of the transcribed speech content, and extracts the user's instructions. Hereafter, the user's instructions also includes the user's requests.

On the other hand, in step S36, the controller 123 determines whether the transition instruction has been issued by operating the switch. In this case, the controller 123 is operating in the speech response mode. The controller 123 determines whether the transition instruction has been issued by operating the switch or by speaking the wake-up word, with reference to the transition instruction information acquired from the memory 122. When the transition instruction has been issued by operating the switch (Yes in step S36), the controller 123 proceeds to step S37. When the transition instruction has not been issued by operating the switch, that is, when the transition instruction has been issued by speaking the wake-up word (No in step S36), the controller 123 proceeds to step S38.

In S37, the controller 123 determines to maintain the display manner of the operation response information. In this case, since the controller 123 has already transitioned to the speech response mode and the display manner of the operation response information has been changed at step S34 in the processing cycle during the transition to the speech response mode, the controller 123 maintains the display manner of the operation response information after the change. The controller 123 then continues to accept instructions by speech in the speech response mode.

On the other hand, in S38, the controller 123 processes the wake-up word as speech. In this case, since the controller 123 has already transitioned to the speech response mode, the controller 123 processes the wake-up word as part of the speech and continues to accept further instructions by speech.

After S35, S37, or S38, the controller 123 ends the procedure in FIG. 3 and continues to operate in the speech response mode.

In the speech response mode, the controller 123 provides services according to the user's speech content. The controller 123 converts the user's speech into text, analyzes the syntax of the text, and extracts instructions from the user's speech. The controller 123 may extract the user's instructions from the speech text using a large language model (LLM). The controller 123 then provides various information or controls operations of equipment of the vehicle 13, according to the user's instructions. For example, when the user requests traffic information, weather information, or information regarding the area, the controller 123 acquires necessary information through vehicle-to-vehicle communication, information distribution from the server apparatus 10, or the like, and presents the information to the user via voice output or image display. When the user instructs to start a multimedia function such as phone or audio, the controller 123 starts the application or function corresponding to the instruction. Furthermore, when the user instructs to adjust the audio volume, adjust the air conditioning, open or close the windows or sunroof, displace the seat, or the like, the controller 123 transmits information to control the device or actuator that performs an operation corresponding to the instruction.

Some of the operations of the controller 123 in the speech response mode may be executed in the server apparatus 10. For example, the controller 123 may transmit data on voice or on text generated from the voice to the server apparatus 10, and when the user's instruction is extracted by LLM in the server apparatus 10, the controller 123 may receive information indicating the user's instruction from the server apparatus 10. Then, the controller 123 provides information and control according to the user's instruction.

As described above, upon receiving a transition instruction in a standby mode, the in-vehicle apparatus 12 displays operation response information in a different manner from speech response information. This makes it easier for a user to grasp that the user should speak according to a speech response mode, thus avoiding unnecessary confusion for the user. Therefore, it is possible to improve user convenience.

While the embodiment has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

Examples of some embodiments of the present disclosure are described below. However, it should be noted that the embodiments of the present disclosure are not limited to these examples.

[Appendix 1] A control apparatus comprising:
an input interface configured to accept an instruction from a user's speech;
a display configured to display information to the user; and
a controller configured to, upon receiving a predetermined instruction to transition to a second operation mode that accepts an instruction from the user's speech while in a first operation mode that stops accepting an instruction from the user's speech, cause the display to display first information that prompts the user to speak and second information other than the first information in different manners from each other.

[Appendix 2] The control apparatus according to appendix 1, wherein the controller is further configured to transition to the second operation mode upon receiving the predetermined instruction.

[Appendix 3] The control apparatus according to appendix 1 or 2, wherein in the second operation mode, the controller is configured to perform an operation in response to the user's instruction to be extracted from the speech.

[Appendix 4] The control apparatus according to any one of appendices 1 to 3, wherein the predetermined instruction is a speech instruction using a predetermined phrase or a predetermined operation instruction.

[Appendix 5] The control apparatus according to any one of appendices 1 to 4, wherein the controller is configured to cause the display to display the second information, as an object to be overlaid on other information.
[Appendix 6] The control apparatus according to any one of appendices 1 to 5, wherein the manner of display of the second information includes a decrease in brightness and being hidden.

[Appendix 7] A method of operating a control apparatus including an input interface configured to accept an instruction from a user's speech and a display configured to display information to the user, the method comprising, upon receiving a predetermined instruction to transition to a second operation mode that accepts an instruction from the user's speech while in a first operation mode that stops accepting an instruction from the user's speech, causing the display to display first information that prompts the user to speak and second information other than the first information in different manners from each other.

[Appendix 8] The method according to appendix 7, further comprising transitioning to the second operation mode upon receiving the predetermined instruction.

[Appendix 9] The method according to appendix 7 or 8, comprising, in the second operation mode, performing an operation in response to the user's instruction to be extracted from the speech.

[Appendix 10] The method according to any one of appendices 7 to 9, wherein the predetermined instruction is a speech instruction using a predetermined phrase or a predetermined operation instruction.

[Appendix 11] The method according to any one of appendices 7 to 10, comprising causing the display to display the second information, as an object to be overlaid on other information.

[Appendix 12] The method according to any one of appendices 7 to 11, wherein the manner of display of the second information includes a decrease in brightness and being hidden.

1. A control apparatus comprising:
an input interface configured to accept an instruction from a user's voice or a physical switch operation;
a display configured to display information to the user; and
a controller configured to, upon receiving a speech instruction using a predetermined word or a predetermined operation instruction to transition to a second operation mode that accepts an instruction from the user's speech while in a first operation mode that stops accepting an instruction from the user's speech, cause the display to display at a lower brightness than first information or to hide second information other than the first information that prompts the user to speak.

2. A control apparatus comprising:
an input interface configured to accept an instruction from a user's speech;
a display configured to display information to the user; and
a controller configured to, upon receiving a predetermined instruction to transition to a second operation mode that accepts an instruction from the user's speech while in a first operation mode that stops accepting an instruction from the user's speech, cause the display to display first information that prompts the user to speak and second information other than the first information in different manners from each other.

3. The control apparatus according to claim 2, wherein the controller is further configured to transition to the second operation mode upon receiving the predetermined instruction.

4. The control apparatus according to claim 3, wherein in the second operation mode, the controller is configured to perform an operation in response to the user's instruction to be extracted from the speech.

5. The control apparatus according to claim 2, wherein the predetermined instruction is a speech instruction using a predetermined phrase or a predetermined operation instruction.

6. The control apparatus according to claim 2, wherein the controller is configured to cause the display to display the second information, as an object to be overlaid on other information.

7. The control apparatus according to claim 2, wherein the manner of display of the second information includes a decrease in brightness and being hidden.

8. A method of operating a control apparatus including an input interface configured to accept an instruction from a user's speech and a display configured to display information to the user, the method comprising, upon receiving a predetermined instruction to transition to a second operation mode that accepts an instruction from the user's speech while in a first operation mode that stops accepting an instruction from the user's speech, causing the display to display first information that prompts the user to speak and second information other than the first information in different manners from each other.

9. The method according to claim 8, further comprising transitioning to the second operation mode upon receiving the predetermined instruction.

10. The method according to claim 9, comprising, in the second operation mode, performing an operation in response to the user's instruction to be extracted from the speech.

11. The method according to claim 8, wherein the predetermined instruction is a speech instruction using a predetermined phrase or a predetermined operation instruction.

12. The method according to claim 8, comprising causing the display to display the second information, as an object to be overlaid on other information.

13. The method according to claim 8, wherein the manner of display of the second information includes a decrease in brightness and being hidden.
